(19) United States
(12) Patent Application Publication
(10) Pub. No.: US 2026/0113804 A1
(43) Pub. Date: Apr. 23, 2026

(54) METHODS FOR ARTIFICIAL INTELLIGENCE/MACHINE LEARNING (AI/ML)-BASED ON/OFF PATTERN CONFIGURATION FOR WTRU POWER SAVING

(71) Applicant: InterDigital Patent Holdings, Inc., Wilmington, DE (US)

(72) Inventors: Mohamed Amine Arfaoui, Montreal (CA); Philip Pietraski, Jericho, NY (US); Guodong Zhang, Woodbury, NY (US); Asil Koc, Verdun (CA); Daniel Steinbach, Commack, NY (US)

(73) Assignee: InterDigital Patent Holdings, Inc., Wilmington, DE (US)

(21) Appl. No.: 18/920,402

(22) Filed: Oct. 18, 2024

(51) Int. Cl. H04W 76/28; H04W 72/0446

(52) U.S. Cl. CPC H04W 76/28; H04W 72/0446

(57) ABSTRACT

A wireless transmit/receive unit (WTRU) may comprise a processor configured to receive configuration information that may include an indication of information to be included in an ON/OFF feedback report and a reporting configuration associated with sending of the ON/OFF feedback report. The processor may receive a network discontinuous reception (DRX) feedback message from the network, determine a state and a reward for a reinforcement learning (RL) model of the WTRU based on the received network DRX feedback message, determine an updated ON/OFF pattern using the RL model of the WTRU based on the state and the reward, and send the on/off feedback report to the network based on the reporting configuration being satisfied.

### BACKGROUND

In order to match diverse data traffic patterns, to take the WTRU battery status into consideration, and to meet the desired latency-energy tradeoff of the WTRU, the network (NW) may determine a discontinuous reception (DRX) pattern (and all relevant DRX parameters) as frequent as every DRX cycle. The NW may have to signal the determined DRX pattern and related parameters to the WTRU in every DRX cycle. The WTRU may turn its circuit ON according to the DRX pattern signaled by the NW in every DRX cycle. This may result in a huge signaling overhead of transmitting the DRX patterns from the NW to the WTRU at every DRX cycle. To overcome this issue, a solution that may enable the WTRU to perform DRX operation without the need of the NW to signal the DRX patterns to the WTRU is highly desired. A solution that may enable the WTRU to learn the best ON/OFF patterns and relevant parameters that match the DRX patterns determined by the NW is highly desired. For systems using DRX for WTRU power saving, methods to enable AI/ML-based DRX may be implemented.

### SUMMARY

A wireless transmit/receive unit (WTRU) may comprise a processor. The processor may be configured to receive configuration information from a network. The configuration may include, for example, an indication of information to be included in an ON/OFF feedback report and a reporting configuration associated with sending of the ON/OFF feedback report. The processor may be configured to receive a network discontinuous reception (DRX) feedback message from the network. The network DRX feedback message may include, for example, an indication of a latency induced from a DRX pattern generated by the network, a latency induced by an ON/OFF pattern determined by the WTRU, or a buffer status of downlink data for the WTRU queued at the network. The processor may be configured to determine a state and a reward for a reinforcement learning (RL) model of the WTRU based on the received network DRX feedback message. The state and the reward may be, for example, inputs to the RL model. The processor may be configured to determine an updated ON/OFF pattern using the RL model of the WTRU based on the state and the reward, wherein the updated ON/OFF pattern is for an interval of time. The interval of time may include, for example, one or multiple time slots, and wherein the number of time slots is configured by the network. The processor may be configured to send the on/off feedback report to the network based on the reporting configuration being satisfied.

The ON/OFF feedback report may include, for example, one or more of battery state information associated with the WTRU, a power profile of the WTRU, a power saving preference of the WTRU, the reward of the RL model of the WTRU, or an indication of the updated on/off pattern.

The processor may be configured to receive from a network (NW) a request to transmit ON/OFF learning and operation capabilities. The processor may be configured to transmit a capabilities message indicating WTRU support for dynamic ON/OFF operation.

The configuration information may include, for example, a network DRX feedback message configuration. The network DRX feedback message may be configured, for example, in accordance with the network DRX feedback message configuration.

The network DRX feedback message configuration may indicate, for example, whether the network DRX feedback message will include one or more of the latency induced from the DRX pattern generated by the network, the latency induced by the ON/OFF pattern determined by the WTRU, the buffer status of the network, or missing ACK/NACK messages.

The state of the RL model may include, for example, a history of one or more of on and off slots, data reception slots, or feedback messages from the network. The reward of the RL model may include, for example, one or more of latency, on time hit ratio, off time miss ratio, or off time ratio.

The processor may be configured to determine the ON/OFF pattern for the next DRX cycle based on the state and the reward of the RL model of the WTRU.

The reporting condition may include, for example, a periodic reporting, an aperiodic reporting, or a semi-persistent reporting.

The reporting condition may include, for example, an event-triggered reporting condition. The event-triggered reporting condition may be based on, for example, a comparison of a value of the reward or a change in the value of the reward and a threshold.

A WTRU may be configured to perform a method that includes one or more of the following steps. The method may include receiving configuration information from a network. The configuration may include, for example, an indication of information to be included in an ON/OFF feedback report and a reporting configuration associated with sending of the ON/OFF feedback report. The method may include receiving a network discontinuous reception (DRX) feedback message from the network. The network DRX feedback message may include, for example, an indication of a latency induced from a DRX pattern generated by the network, a latency induced by an ON/OFF pattern determined by the WTRU, or a buffer status of downlink data for the WTRU queued at the network. The method may include determining a state and a reward for a reinforcement learning (RL) model of the WTRU based on the received network DRX feedback message. The state and the reward may be, for example, inputs to the RL model. The method may include determining an updated ON/OFF pattern using the RL model of the WTRU based on the state and the reward, wherein the updated ON/OFF pattern is for an interval of time. The interval of time may include, for example, one or multiple time slots, and wherein the number of time slots is configured by the network. The method may include sending the on/off feedback report to the network based on the reporting configuration being satisfied.

The ON/OFF feedback report may include, for example, one or more of battery state information associated with the WTRU, a power profile of the WTRU, a power saving preference of the WTRU, the reward of the RL model of the WTRU, or an indication of the updated on/off pattern.

The method may include receiving from a network (NW) a request to transmit ON/OFF learning and operation capabilities. The method may include transmitting a capabilities message indicating WTRU support for dynamic ON/OFF operation.

The configuration information may include, for example, a network DRX feedback message configuration. The network DRX feedback message may be configured, for example, in accordance with the network DRX feedback message configuration.

The network DRX feedback message configuration may indicate, for example, whether the network DRX feedback message will include one or more of the latency induced from the DRX pattern generated by the network, the latency induced by the ON/OFF pattern determined by the WTRU, the buffer status of the network, or missing ACK/NACK messages.

The state of the RL model may include, for example, a history of one or more of on and off slots, data reception slots, or feedback messages from the network. The reward of the RL model may include, for example, one or more of latency, on time hit ratio, off time miss ratio, or off time ratio.

The method may include determining the ON/OFF pattern for the next DRX cycle based on the state and the reward of the RL model of the WTRU.

The reporting condition may include, for example, a periodic reporting, an aperiodic reporting, or a semi-persistent reporting.

The reporting condition may include, for example, an event-triggered reporting condition. The event-triggered reporting condition may be based on, for example, a comparison of a value of the reward or a change in the value of the reward and a threshold.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating an example visualization of a Markov Decision Process (MDP) according to an embodiment.

FIG. 3 is a diagram illustrating an example basic discontinuous reception (DRX) operation according to an embodiment.

FIG. 4 is a diagram illustrating an example long and short DRX cycles according to an embodiment.

FIG. 5 is a diagram illustrating an example network and wireless transmit/receive unit (WTRU) procedures to learn on/off pattern according to an embodiment.

FIG. 6 is a diagram illustrating an example WTRU procedures for dynamic on/off operations according to an embodiment.

### DETAILED DESCRIPTION

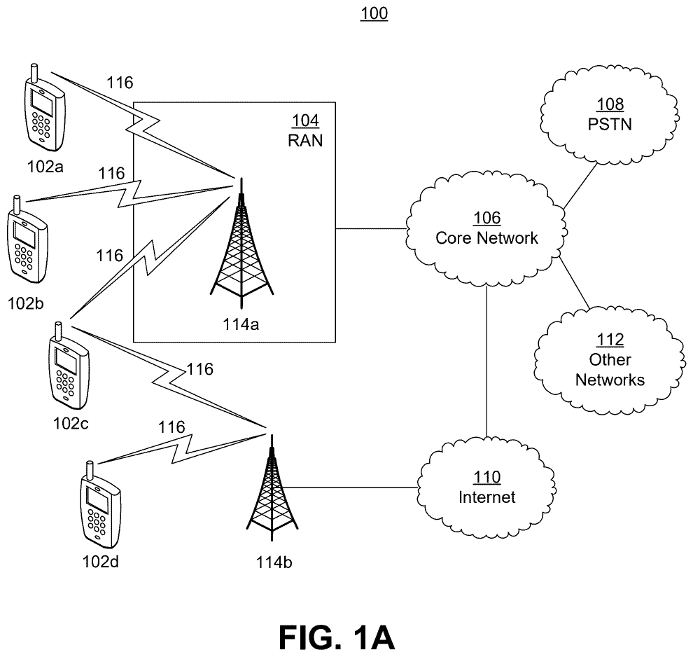

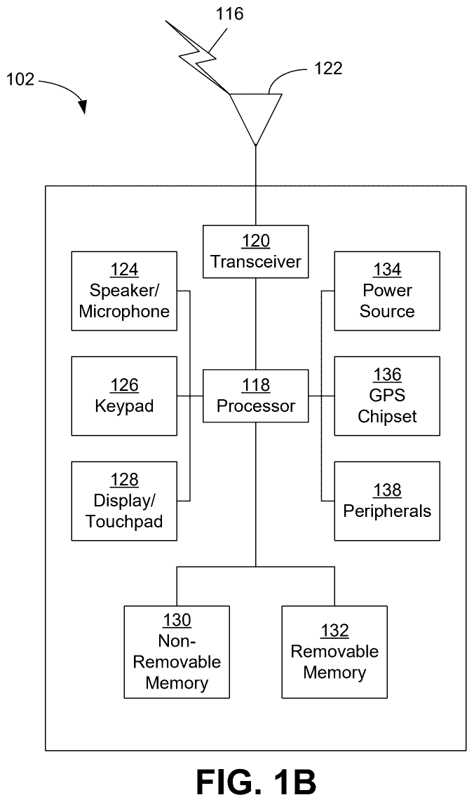

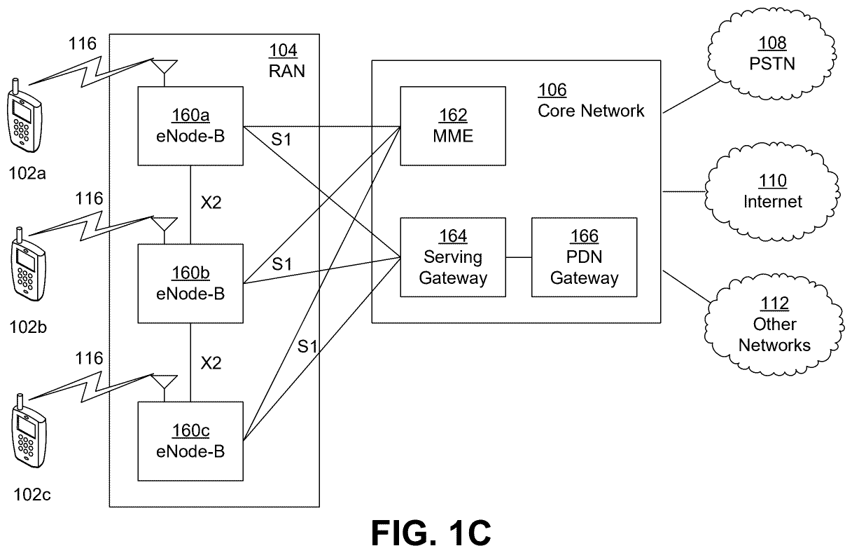

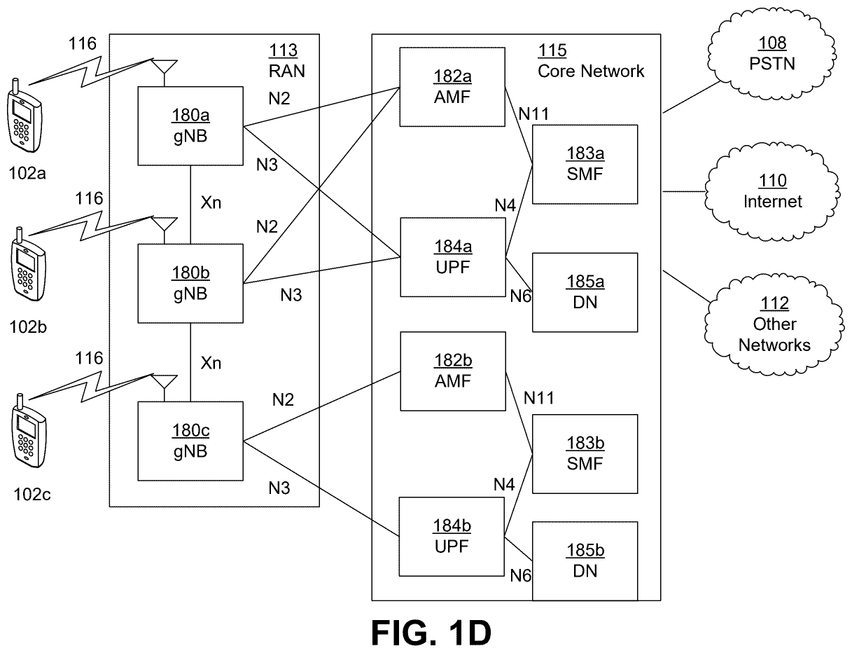

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The WTRU may be enabled to learn dynamic ON/OFF patterns for its circuits under DRX operations in a way that may match the best DRX patterns decided by the network (NW), the traffic pattern, and the WTRU battery state.

Artificial intelligence (AI) may be broadly defined as the behavior exhibited by machines that mimic cognitive functions to sense, reason, adapt and act. An AI component may refer to the realization of behaviors and/or conformance to requirements by learning based on data, without explicit configuration of sequence of steps of actions. Such AI component may enable learning complex behaviors which might be difficult to specify and/or implement when using legacy methods.

Machine learning (ML) may refer to the type of algorithms that solve a problem based on learning through experience (‘data’), without being explicitly programmed (‘configuring a set of rules’). ML may be considered as a subset of AI. Different ML paradigms may be envisioned based on the nature of data or feedback available to the learning algorithm. In some examples, a supervised learning approach may involve learning a function that maps input to an output based on labeled training example, wherein each training example may be a pair consisting of an input and its corresponding output. In some examples, an unsupervised learning approach may involve detecting patterns in the data with no pre-existing labels. In some examples, a reinforcement learning approach may involve performing sequence of actions in an environment to maximize the cumulative reward. In some examples, it may be possible to apply ML algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning refers to a class of ML algorithms that employ artificial neural networks, specifically, Deep Neural Networks (DNNs), which were loosely inspired from biological systems. The DNNs are a special class of ML models that are inspired by the human brain wherein the input is linearly transformed and pass-through non-linear activation function multiple times. DNNs may consist of multiple layers where each layer consists of linear transformation and a given non-linear activation functions. The DNNs can be trained using the training data via back-propagation algorithm. DNNs have shown state-of-the-art performance in a variety of domains, e.g., speech, vision, natural language, wireless communication, etc., and for various ML settings (supervised, un-supervised, semi-supervised, etc.).

Reinforcement learning (RL) is a branch of ML that focuses on decision-making by autonomous agents. An autonomous agent represents a system capable of making independent decisions and responding to its surroundings without direct human intervention. By contrast to supervised and supervised learning, RL agents learn to act and to execute tasks through trial and error, without explicit human guidance. This approach specifically tackles sequential decision-making challenges within dynamic environments.

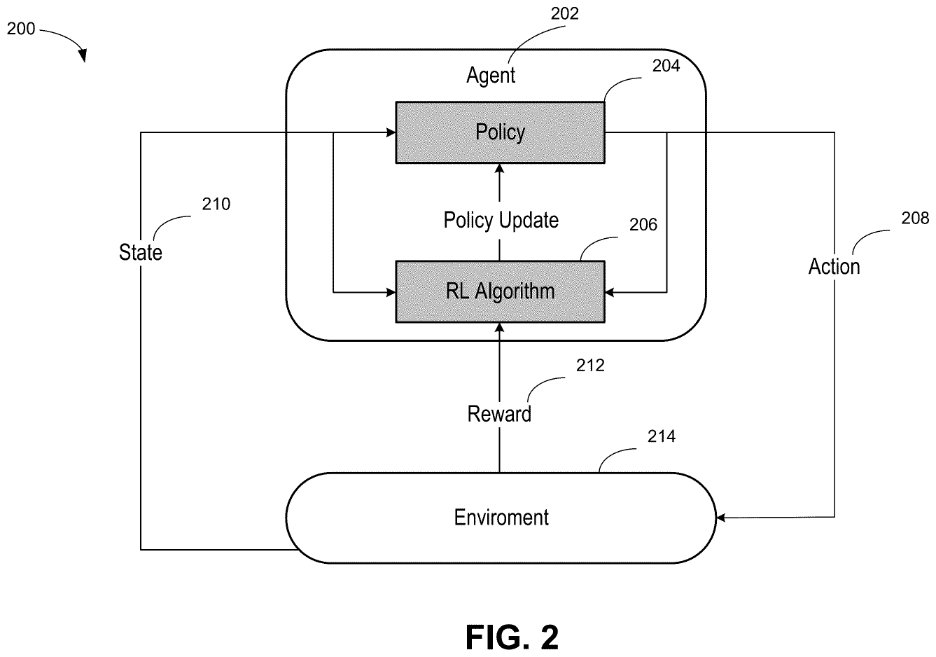

RL may consist of the relationship between an agent, an environment, and a goal. As depicted in FIG. 2, this relationship may be formulated in terms of the Markov decision process (MDP). The reinforcement learning agent learns about a problem by interacting with its environment. The environment provides information on its current state. The agent may then use that information to determine which actions to take. The decided action may move the environment from its current state to a new state. If that action obtains a positive reward signal from the surrounding environment, the agent may be encouraged to take that action again when in a similar future state. This process repeats for every new state thereafter. Over time, the agent may learn from rewards to take actions within the environment that meet a specified goal. In MDP, state space may refer to the space of all possible states an environment's might be in. In MDP, action space may refer to the space of all possible actions the agent may take upon receiving a state and a reward from the environment.

FIG. 2 is a system diagram illustrating an example visualization of a Markov Decision Process (MDP) according to an embodiment. System 200 illustrates, as an example, that the agent 202 may contain two components: a policy 204 and a learning algorithm 206. The policy 204 may be a mapping from the current state to a probability distribution of the actions to be taken. Within an agent, the policy may be implemented by a function approximator with tunable parameters and a specific approximation model, such as neural networks. The learning algorithm 206 may continuously update the policy parameters based on the actions 208, states 210, and rewards 212. The goal of the learning algorithm 206 may be to find an optimal policy that maximizes the expected cumulative long-term reward. Because an RL agent 202 has no manually labeled input data guiding its behavior, it may explore its environment 214, attempting new actions to discover those that receive rewards. From these reward signals, the agent may learn to prefer actions for which it was rewarded in order to maximize its gain. But the agent may continue exploring new states and actions as well. In doing so, it may use that experience to improve its decision-making. RL algorithms may require an agent to both exploit knowledge of previously rewarded state-actions and explore other state-actions. The agent may not exclusively pursue exploration or exploitation. It may continuously try new actions while also preferring single and/or chains of actions that produce the largest cumulative reward.

A study on WTRU power saving in NR may be implemented to study WTRU power saving framework taking into consideration the latency and performance in NR as well as NW impact. The study of WTRU power saving in NR may include the study of the power saving schemes and the associated procedures. The power saving schemes may be to study the WTRU adaptation to the traffic and to WTRU power consumption characteristics in frequency, time, antenna domains, DRX configuration, and reducing physical downlink control channel (PDCCH) monitoring and/or decoding.

Discontinuous Reception (DRX) is a power-saving mechanism used in mobile communication systems to extend the battery life of WTRUs. The basic idea is to allow WTRUs to periodically turn off their receivers and enter a low-power state, waking up only at specific intervals to check for incoming data or signals. This may help in reducing power consumption during OFF periods. 5G NR DRX involves specific configurations and parameters related to DRX in the 5G New Radio interface. It is designed to enhance the power efficiency of WTRU by controlling when the WTRU may turn on or turn off its receiver.

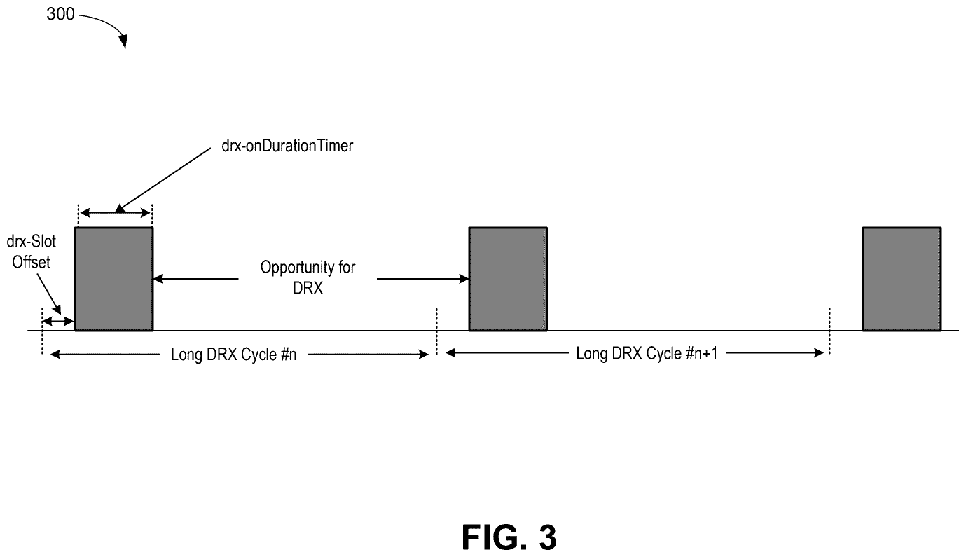

FIG. 3 is a diagram illustrating an example basic discontinuous reception (DRX) operation according to an embodiment. During DRX mode, the WTRU may conserve power by shutting down most of its circuitry when there's no data to receive or transmit. As shown in diagram 300, the WTRU in this state periodically may listen to the physical downlink control channel (PDCCH), known as the active state or DRX ON period. Conversely, when the WTRU doesn't monitor the PDCCH, the WTRU may be in the DRX Sleep state or DRX OFF period.

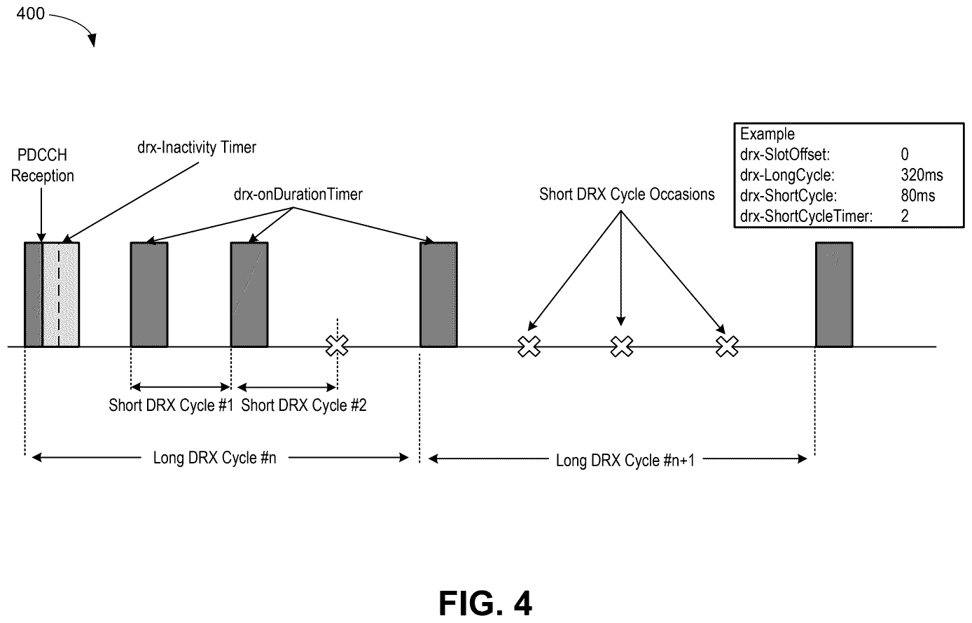

FIG. 4 is a diagram illustrating an example of long and short DRX cycles according to an embodiment. Key aspects of 5G NR DRX are shown in diagram 400. For example, the DRX cycle defines the duration for which the WTRU may remain in an active state before entering a low-power state. The DRX cycle may be divided into on-duration (active state) and off-duration (low-power state). Different DRX configurations may be defined to suit various NW and WTRU requirements. This may include setting parameters such as DRX cycle length, on-duration, and off-duration. Long DRX cycle may refer to a DRX configuration with a long cycle duration, which may be suitable for scenarios where the device can afford to stay in a low-power state for extended periods. Short DRX cycle may refer to a DRX configuration with a short cycle duration, suitable for scenarios where the device may need to be more responsive and cannot afford long periods of inactivity. Connected mode DRX (cDRX) may be a key feature for WTRU energy saving. In connected mode, where the device may be actively communicating with the NW, cDRX may allow the device to periodically switch between active and low-power states. This may be particularly useful when the WTRU expects incoming data but wants to conserve power during idle periods. cDRX may provide two levels of monitoring granularity via the short and long DRX configurations. cDRX allows the device to only monitor scheduling messages during well-defined monitoring intervals (e.g., during 10 ms on-durations once every 160 ms in long DRX). The rest of the time the device may remain in sleep mode.

Methods for AI/ML-based ON/OFF pattern configuration for WTRU power saving may be implemented. The method may provide dynamic ON/OFF patterns operations at the WTRU. Specifically, the method may enable the WTRU to learn ON/OFF patterns, with the assistance of the NW, in a way that better matches the pattern of downlink traffic for the WTRU and DRX patterns decided by the NW. The method may take the WTRU battery state into consideration. The method may meet the service latency requirements. AI/ML methods may be considered given that the traffic patterns, the decided DRX patterns by the NW and/or the desired ON/OFF patterns may be learned. The NW may schedule the downlink (DL) data transmission to the WTRU during DRX cycles with configurable durations that may be either constant or variable. Within each DRX cycle, the NW may schedule the DL data transmission to the WTRU during DRX ON duration slots (or time windows) with configurable durations. To reduce the overhead resulting from dynamic DRX operations, the NW may not signal the WTRU with parameters of the DRX pattern. The WTRU, with the assistance of the NW, may decide on which time slot it should turn ON and transmits the results of its ON/OFF pattern decision as feedback to the NW.

The WTRU may use various AI/ML solutions to learn the ON/OFF pattern. For example, deciding the ON/OFF patterns by the WTRU may be modeled as a Markov Decision Process (MDP), and may be realized through Reinforcement Learning (RL) techniques. RL hides the complexity of the environment, and RL may make efficient and quick decisions that adapt according to the traffic patterns, the DRX pattern, the WTRU battery state, and/or the latency-energy tradeoff. RL may learn with time and adapts to different and unseen situations. For example, this method may enable the WTRU to employ RL techniques to learn dynamic ON/OFF patterns with the assistance of the NW.

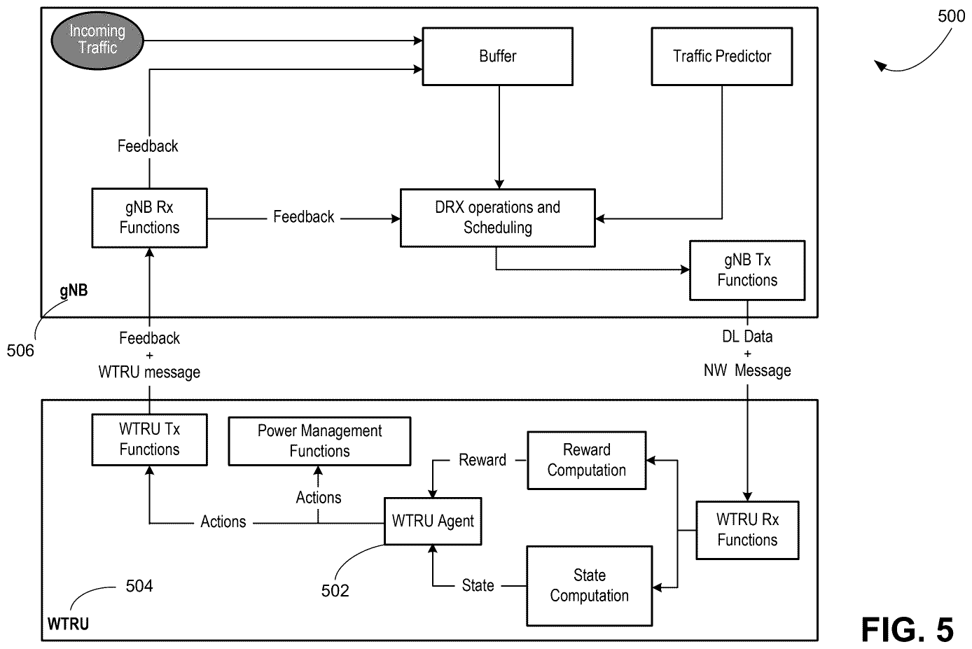

FIG. 5 is a diagram illustrating an example network and wireless transmit/receive unit (WTRU) procedures to learn ON/OFF patterns according to an embodiment. For example, diagram 500 illustrates an embodiment of the component of the MDP deciding the ON/OFF patterns by the WTRU. For example, the WTRU agent action 502 is the ON/OFF pattern (e.g., the ON/OFF decision at each slot). The WTRU 504 may turn its circuit ON/OFF based on the decided ON/OFF pattern. When the WTRU 504 turns its circuit ON, it may detect DCI carrying DL or UL grants. The WTRU may report a positive acknowledgement (ACK) or negative acknowledgement (NACK) for the received DL data to the NW 506. The WTRU may report its battery state information to the NW 506 for effective DRX pattern decisions at the NW 506. Reporting the battery state information and other information such as target battery recharge time to the NW 506 may be either periodic, aperiodic, or semipersistent. Battery related information may be used locally by the WTRU agent 502 to make the ON/OFF decisions. The NW 506 may receive the feedback from the WTRU 504 and may include this information when deciding on its DRX pattern for the next DRX cycle. Additionally and/or alternatively, the NW 506 may transmit to the WTRU 504 feedback related to its decided ON/OFF pattern such as the statistics of missing ACK or NACK from the WTRU (e.g., discontinuous transmit (DTX)). The WTRU 504 may compute the reward and may determine the new state associated to the WTRU agent 502 actions. The WTRU 504 may be able to intentionally be OFF during ON slots in the DRX cycle. Since ON slots in the DRX pattern may happen without any DCI carrying DL or UL grants for the WTRU, intentionally being OFF during ON slots in the DRX cycle may provide the WTRU 504 with the possibility of further reducing power consumption especially when battery is low and/or the time to next recharge is long.

The NW 506 may limit or not signal NW DRX feedback message to the WTRU 504 explicitly and the WTRU 504 may limit or not signal the ON/OFF feedback report to the NW 506. The NW 506 may piggyback a DRX message to the WTRU 504 and/or the WTRU 504 may piggyback an ON/OFF message to the NW 506 when other transmissions in the same direction are present. This limiting, not signaling and/or piggybacking may result in very little extra power used by the WTRU. The creation and signaling of a DRX message may be viewed as an action of the NW and the creation and signaling of an ON/OFF message may be viewed as an action of the WTRU. For example, a DRX message may be the estimated next ON time and/or estimated next KON times, etc. Additionally and/or alternatively, the DRX message and the ON/OFF message may be a learnable message or ML based compression thereof.

The WTRU agent reward may include a combination of the following. For example, the WTRU agent reward may include latency induced by the ON/OFF pattern decided by the WTRU in the end-to-end latency (e.g., the latency caused by the WTRU being OFF while there is actual DL data transmission). The WTRU agent reward may include WTRU ON time hit ratio (e.g., a positive reward for WTRU turning ON when data is sent and negative reward for WTRU turning ON when data is not sent. The WTRU agent reward may include WTRU OFF time miss ratio (e.g., negative reward for WTRU being OFF when data is sent, which can be measured by the NW missing ACK or NACK, and a positive reward for WTRU being ON when data is sent). The WTRU agent reward may include WTRU OFF time ratio (e.g., computed from the ON/OFF pattern decided by the WTRU agent and measures the fraction of time the WTRU circuit was turned OFF. The WTRU OFF time ratio measures the efficacy of the decided ON/OFF in saving the WTRU power).

An equation for the reward may be expressed as Equation (1), but other equations may exist:

$$Reward = {f}_{1} ( L ) + {f}_{2} ( {T}_{hit} ) + {f}_{3} ( {T}_{miss} ) + {f}_{4} ( {T}_{OFF} ) , \qquad ( 1 )$$

Where L denotes the latency indicated above, Tₕᵢₜ denotes the WTRU ON time hit ratio indicated above, Tₘᵢₛₛ denotes the WTRU OFF time miss ratio indicated above, and T_{OFF} denotes the WTRU OFF time indicated above. The functions f₁, f₂, f₃, and f₄, may be four functions that map the quantities L, Tₕᵢₜ, Tₘᵢₛₛ, and T_{OFF}, respectively, to the reward. Each one of the functions f₁, f₂, f₃, and f₄, is characterized as follows. For example, the functions f₁, f₂, f₃, and f₄ may be either constant or learnable. The functions f₁, f₂, f₃, and f₄ may be polynomial (linear, quadratic, etc.), rational, AI/ML model, etc. The functions f₁, f₂, f₃, and f₄ may be fully configured by the NW, jointly configured by the NW and the WTRU, (e.g., parts are configured by the NW and parts are configured by the WTRU), and/or fully configured by the WTRU.

The WTRU agent state may consist of the following metrics. For example, the WTRU agent state may consist of the history of ON and OFF slots recorded from the WTRU ON/OFF pattern. The WTRU agent state may consist of the history of data reception slots (e.g., the slots that corresponds to the WTRU being ON and receiving DL data). The WTRU agent state may consist of the history of feedback messages from the NW. The history of feedback messages from the NW which may include missing ACK or NACK (e.g., DTX), latency induced from the DRX pattern generated by the NW and the ON/OFF pattern decided by the WTRU, and/or buffer status, etc. After the WTRU agent computes the state and the reward, the WTRU agent may decide the ON/OFF pattern for the next DRX cycle, and the entire procedure may be repeated for subsequent slots.

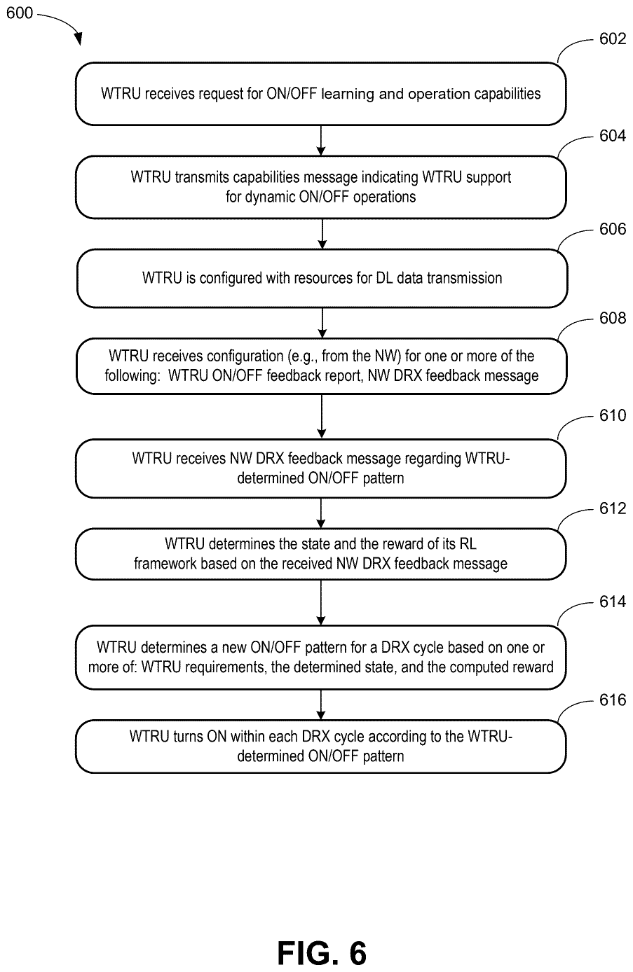

FIG. 6 is an example of a procedure for a WTRU method to learn the ON/OFF pattern. The NW may refer to any node in the network (e.g., gNB and/or another WTRU (e.g., Sidelink, WTRU-to-WTRU direct communication, etc.)). The procedure 600 may be performed by a WTRU. At 602, the WTRU may receive (e.g., from the NW), a request to report its ON/OFF learning and operation capabilities. The WTRU may transmit its capabilities to the NW by means of Radio Resource Control (RRC) signaling. At 604, the WTRU may transmit a capabilities message indicating WTRU support for dynamic ON/OFF operation. At 606, the WTRU may receive DL grant allocating radio resources for DL data transmission. The downlink radio resources allocation may occur during any ON slot in a DRX cycle. The WTRU may receive the radio resource allocations dynamically (e.g., through downlink control information (DCI) or medium access control-control element (MAC-CE)).

At 608, the WTRU may receive configuration information (e.g., from the NW) for one or more of the following. For example, the WTRU may receive a WTRU ON/OFF feedback report configuration. The WTRU ON/OFF feedback report may include the messages and parameters that should be included in the WTRU ON/OFF feedback report, such as WTRU battery state information, WTRU power profile, WTRU power saving preferences, along with any other relevant information related to the WTRU power saving mechanism and to the latency-energy tradeoff requirement for the WTRU, Reward of the WTRU RL framework for training and/or performance monitoring purpose, and/or WTRU-determined ON/OFF pattern (e.g., the ON Slots during the DRX cycle). In some instances, the configuration information may be a reporting condition associated with sending of a ON/OFF feedback report.

In some instances, the WTRU ON/OFF feedback report configuration may include the reporting mechanism, also referred to as reporting condition and/or reporting configuration (e.g., triggering conditions) of the WTRU ON/OFF feedback report. For example, the reporting condition of the WTRU ON/OFF feedback report may be time-based feedback reporting (e.g., the WTRU ON/OFF feedback report can be periodic, aperiodic, or semi-persistent). For example, the mechanism to trigger a transmission of the WTRU ON/OFF feedback report may be event-trigger based feedback reporting. For instance, the WTRU computes a certain parameter associated to the reward of its RL framework at the NW. The triggering event of feedback reporting may include the WTRU comparing the computed parameter to some thresholds configured by the NW. The WTRU transmitting of the WTRU ON/OFF feedback report will be triggered if the computed parameter is lower or higher than one of the configured thresholds. Alternatively, the reporting condition of the WTRU ON/OFF feedback report may be a mixture of time-based feedback reporting and event-trigger based feedback reporting. The WTRU may transmit its ON/OFF feedback report upon receiving a request from the NW.

In some instances, the WTRU ON/OFF feedback report configuration can be either preconfigured, configured by means of radio resource control (RRC) signaling, and/or dynamically configured (e.g., through DCI or MAC-CE). In some instances, the WTRU ON/OFF feedback report configuration may include the signal type(s) and/or the uplink resource configuration and/or allocations that may carry the WTRU ON/OFF feedback report. For example, the resource that may carry the WTRU ON/OFF feedback report may be the physical uplink shared channel (PUSCH), physical uplink control channel (PUCCH); the signal to carry the WTRU ON/OFF feedback report may be RRC, uplink control information (UCI), and/or MAC-CE. In some examples, a WTRU may report WTRU ON/OFF feedback report in a hybrid automatic repeat request (HARQ) ACK report (e.g., appended to or multiplexed with a HARQ-ACK report).

The WTRU may receive the configuration of NW DRX feedback message. The NW DRX feedback message may include latency induced from the DRX pattern generated by the NW and/or the WTRU-determined ON/OFF pattern determined by the WTRU. The NW DRX feedback message may include buffer status of DL data for the WTRU. The NW DRX feedback message may include the statistics of missing ACK/NACK messages (e.g., possibly resulting from the WTRU-determined ON/OFF pattern operations). In some examples, the NW DRX feedback message configuration may include the type(s) of signals and/or the downlink resource configuration and/or allocations that carry the NW DRX feedback message. For example, the WTRU may receive the feedback message dynamically (e.g., through DCI or MAC-CE). For example, the NW may ‘piggyback’ the feedback message when other DL transmissions are present.

At 610, the WTRU may receive NW feedback message regarding WTRU-determined ON/OFF pattern. At 612, the WTRU may determine the state and/or the reward of its RL framework based on the received NW DRX feedback message. The state may include ON and OFF slots (e.g., recorded from the WTRU-determined ON/OFF pattern). The state may include data reception slots (e.g., the slots that correspond to the WTRU being ON and receiving DL data). The state may include feedback messages from the NW (e.g., which may include latency induced from the DRX pattern generated by the NW and the WTRU-determined ON/OFF pattern, buffer status, and/or missing ACK/NACK, etc.). The reward may be one or more of the following metrics. For example, the reward may include latency induced by the WTRU-determined ON/OFF pattern decided by the WTRU in the end-to-end latency (e.g., the latency caused by the WTRU being OFF while there is actual DL data transmission). The reward may include the WTRU ON time hit ratio (e.g., positive reward for WTRU turning ON when data is sent and negative reward for WTRU turning ON when data is not sent). The reward may include the WTRU OFF time miss ratio (e.g., negative reward for WTRU being OFF when data is sent, which can be measured by the NW missing ACK/NACK, and positive reward for WTRU being OFF). The reward may include the WTRU OFF time ratio (e.g., computed from the WTRU-determined ON/OFF pattern decided by the WTRU agent and measures the fraction of time the WTRU circuit was turned OFF). The metric of WTRU OFF time ratio may measure the efficacy of the WTRU-determined ON/OFF in saving the WTRU power. At 614, the WTRU may determine a new and/or updated ON/OFF pattern for a DRX cycle based on the determined state, and/or the computed reward. The new and/or updated ON/OFF pattern may be for an interval of time. The interval of time may be one or multiple time slots, and the number of time slots may be configured by the NW.

In some examples, the WTRU may transmit the WTRU ON/OFF feedback report to the NW according to the configured reporting condition (e.g. reporting condition being satisfied). For instance, the WTRU may be configured to transmit the WTRU ON/OFF feedback report as the UCI, transmitted on PUCCH and/or PUSCH. At 616, the WTRU may turn ON within each DRX cycle according to the WTRU-determined ON/OFF pattern (e.g., the WTRU monitors for PDCCH during the ON slots). The WTRU-determined ON/OFF pattern may be determined based on the state and the reward of the RL model at the WTRU.

Additional and/or alternative steps to enable monitoring or the learning performance may be implemented. In some examples, the WTRU may monitor the learning performance of the ON/OFF pattern by monitoring the evolution of the computed reward over one or more DRX cycles. For instance, the WTRU may continue learning the ON/OFF pattern in a continuous mode (e.g., the WTRU may keep updating continuously the RL policy of generating the ON/OFF pattern from the determined state and reward using the configured RL algorithm). For instance, the WTRU may decide to stop learning the ON/OFF pattern when the RL policy converges (e.g., when the computed reward is higher than a certain threshold). In some examples, the WTRU may deactivate the RL algorithm and/or stop updating the RL policy of generating the ON/OFF pattern from the determined state and reward. In some examples, the WTRU may monitor the performance of the ON/OFF pattern against any possible drift. For example, the WTRU may store the reward values associated to the WTRU-determined ON/OFF pattern. If the reward is decreasing and/or becomes smaller than a threshold, the WTRU may activate the RL algorithm and/or start updating the RL policy. In some examples, the WTRU may transmit an indication indicating whether the RL algorithm is activated and/or deactivated.

Additional and/or alternative steps to report the computed rewards of the RL algorithm may be implemented. For example, the WTRU may report the computed rewards associated to the WTRU-determined ON/OFF patterns to the NW.

Additional and/or alternative steps to receive indication to activate/deactivate the RL algorithm may be implemented. For example, the WTRU may receive an indication from the NW to activate and/or deactivate the RL algorithm (e.g., learning the ON/OFF pattern). For instance, if the WTRU receives an indication from the NW to activate, the WTRU activates the RL algorithm and/or starts updating the RL policy (e.g., if the RL policy is drifting). For instance, if the WTRU receives an indication from the NW to deactivate, the WTRU deactivates the RL algorithm and/or stops updating the RL policy of generating the ON/OFF pattern from the determined state and reward.

Additional and/or alternative steps from the NW may be implemented. For example, the NW may receive the WTRU ON/OFF feedback report from the WTRU. The NW may transmit a feedback message to the WTRU based on NW-determined DRX pattern and/or WTRU-determined ON/OFF pattern.

Methods for AI/ML-based ON/OFF pattern configuration for WTRU power saving may be implemented. The method may provide dynamic ON/OFF patterns operations at the WTRU. Specifically, the method may enable the WTRU to learn ON/OFF patterns, with the assistance of the NW, in a way that better matches the pattern of downlink traffic for the WTRU and DRX patterns decided by the NW. The method may take the WTRU battery state into consideration. The method may meet the service latency requirements. AI/ML methods may be considered given that the traffic patterns, the decided DRX patterns by the NW and/or the desired ON/OFF patterns may be learned. The NW may schedule the downlink (DL) data transmission to the WTRU during DRX cycles with configurable durations that may be either constant or variable. Within each DRX cycle, the NW may schedule the DL data transmission to the WTRU during DRX ON duration slots (or time windows) with configurable durations. To reduce the overhead resulting from dynamic DRX operations, the NW may not signal the WTRU with parameters of the DRX pattern. The WTRU, with the assistance of the NW, may decide on which time slot it should turn ON and transmits the results of its ON/OFF pattern decision as feedback to the NW.

The WTRU may use various AI/ML solutions to learn the ON/OFF pattern. For example, deciding the ON/OFF patterns by the WTRU may be modeled as a Markov Decision Process (MDP), and may be realized through Reinforcement Learning (RL) techniques. RL hides the complexity of the environment, and RL may make efficient and quick decisions that adapt according to the traffic patterns, the DRX pattern, the WTRU battery state, and/or the latency-energy tradeoff. RL may learn with time and adapts to different and unseen situations. For example, this method may enable the WTRU to employ RL techniques to learn dynamic ON/OFF patterns with the assistance of the NW.

FIG. 5 is a diagram illustrating an example network and wireless transmit/receive unit (WTRU) procedures to learn ON/OFF patterns according to an embodiment. For example, diagram 500 illustrates an embodiment of the component of the MDP deciding the ON/OFF patterns by the WTRU. For example, the WTRU agent action 502 is the ON/OFF pattern (e.g., the ON/OFF decision at each slot). The WTRU 504 may turn its circuit ON/OFF based on the decided ON/OFF pattern. When the WTRU 504 turns its circuit ON, it may detect DCI carrying DL or UL grants. The WTRU may report a positive acknowledgement (ACK) or negative acknowledgement (NACK) for the received DL data to the NW 506. The WTRU may report its battery state information to the NW 506 for effective DRX pattern decisions at the NW 506. Reporting the battery state information and other information such as target battery recharge time to the NW 506 may be either periodic, aperiodic, or semipersistent. Battery related information may be used locally by the WTRU agent 502 to make the ON/OFF decisions. The NW 506 may receive the feedback from the WTRU 504 and may include this information when deciding on its DRX pattern for the next DRX cycle. Additionally and/or alternatively, the NW 506 may transmit to the WTRU 504 feedback related to its decided ON/OFF pattern such as the statistics of missing ACK or NACK from the WTRU (e.g., discontinuous transmit (DTX)). The WTRU 504 may compute the reward and may determine the new state associated to the WTRU agent 502 actions. The WTRU 504 may be able to intentionally be OFF during ON slots in the DRX cycle. Since ON slots in the DRX pattern may happen without any DCI carrying DL or UL grants for the WTRU, intentionally be OFF during ON slots in the DRX cycle may provide the WTRU 504 with the possibility of further reducing power consumption especially when battery is low and/or the time to next recharge is long.

The NW 506 may limit or not signal DRX pattern information to the WTRU explicitly. The NW 506 may piggyback the NW DRX feedback message and/or the WTRU 504 may piggyback the ON/OFF feedback report when other transmissions in the same direction are present. This limiting, not signaling and/or piggybacking may result in very little extra power used by the WTRU. The creation and signaling of a DRX related message may be viewed as an action of the sending agent and part of the environment of the receiving agent. For example, a DRX message may be the estimated next ON time and/or estimated next KON times, etc. Additionally and/or alternatively, the message itself may be a learnable message or ML based compression thereof.

The WTRU agent reward may include a combination of the following. For example, the WTRU agent reward may include latency induced by the ON/OFF pattern decided by the WTRU in the end-to-end latency (e.g., the latency caused by the WTRU being OFF while there is actual DL data transmission). The WTRU agent reward may include WTRU ON time hit ratio (e.g., a positive reward for WTRU turning ON when data is sent and negative reward for WTRU turning ON when data is not sent. The WTRU agent reward may include WTRU OFF time miss ratio (e.g., negative reward for WTRU being OFF when data is sent, which can be measured by the NW missing ACK or NACK, and a positive reward for WTRU being ON when data is sent). The WTRU agent reward may include WTRU OFF time ratio (e.g., computed from the ON/OFF pattern decided by the WTRU agent and measures the fraction of time the WTRU circuit was turned OFF. The WTRU OFF time ratio measures the efficacy of the decided ON/OFF in saving the WTRU power).

An equation for the reward may be expressed as Equation (1), but other equations may exist:

$$Reward = {f}_{1} ( L ) + {f}_{2} ( {T}_{hit} ) + {f}_{3} ( {T}_{miss} ) + {f}_{4} ( {T}_{OFF} ) , \qquad ( 1 )$$

Where L denotes the latency indicated above, Tₕᵢₜ denotes the WTRU ON time hit ratio indicated above, Tₘᵢₛₛ denotes the WTRU OFF time miss ratio indicated above, and T_{OFF} denotes the WTRU OFF time indicated above. The functions f₁, f₂, f₃, and f₄, may be four functions that map the quantities L, Tₕᵢₜ, Tₘᵢₛₛ, and T_{OFF}, respectively, to the reward. Each one of the functions f₁, f₂, f₃, and f₄, is characterized as follows. For example, the functions f₁, f₂, f₃, and f₄ may be either constant or learnable. The functions f₁, f₂, f₃, and f₄ may be polynomial (linear, quadratic, etc.), rational, AI/ML model, etc. The functions f₁, f₂, f₃, and f₄ may be fully configured by the NW, jointly configured by the NW and the WTRU, (e.g., parts are configured by the NW and parts are configured by the WTRU), and/or fully configured by the WTRU.

The WTRU agent state may consist of the following metrics. For example, the WTRU agent state may consist of the history of ON and OFF slots recorded from the WTRU ON/OFF pattern. The WTRU agent state may consist of the history of data reception slots (e.g., the slots that corresponds to the WTRU being ON and receiving DL data). The WTRU agent state may consist of the history of feedback messages from the NW. The history of feedback messages from the NW which may include missing ACK or NACK (e.g., DTX), latency induced from the DRX pattern generated by the NW and the ON/OFF pattern decided by the WTRU, and/or buffer status, etc. After the WTRU agent computes the state and the reward, the WTRU agent may decide the ON/OFF pattern for the next DRX cycle, and the entire procedure may be repeated for subsequent slots.

The WTRU may use an AI/ML model for AI/ML-based ON/OFF pattern configuration for WTRU Power Saving. The WTRU may train the AI/ML model through the RL framework with the assistance of the NW feedback. For example, the WTRU may receive a NW DRX feedback message regarding the WTRU-determined ON/OFF pattern. The WTRU may determine the state and the reward with the assistance of the NW DRX feedback message transmitted by the NW. For example, the stages of the AI/ML process (e.g., the RL framework) may include one or more of the following. For example, the stages of the AI/ML process may include “Application” (e.g., ON/OFF pattern configuration for WTRU Power Saving). The stages of the AI/ML process may include “Agent”. For instance, the RL agent may learn about a problem by interacting with its environment. Through trial and error, the RL agents may learn to act and to execute tasks. The RL agent may learn from rewards and penalties to take actions within the environment that meet a predefined goal (e.g., ON/OFF pattern configuration for WTRU Power Saving). In a disclosed method herein, the RL agent may be located at the WTRU to decide on the ON/OFF pattern configuration for WTRU Power Saving through the determined state and the computed reward. The stages of the AI/ML process may include “State”. For instance, the state may mean the situation of the environment that the RL agent considers while taking an action. For the ON/OFF Pattern Configuration for WTRU Power Saving, the state may include one or more of the following. For example, the state may include ON and OFF slots (e.g., recorded from the WTRU-determined ON/OFF pattern). The state may include data reception slots (e.g., the slots that corresponds to the WTRU being ON and receiving DL data). The state may include feedback messages from the NW (e.g., latency induced from the DRX pattern generated by the NW and the WTRU-determined ON/OFF pattern, buffer status, and/or missing ACK/NACK, etc.). The stages of the AI/ML process may include “Reward”. For instance, the WTRU agent reward for the ON/OFF pattern configuration for WTRU power saving may be one or more of the following. For example, the reward may be latency induced by the WTRU-determined ON/OFF pattern decided by the WTRU in the end-to-end latency (e.g., the latency caused by the WTRU being OFF while there is actual DL data transmission). The reward may be WTRU ON time hit ratio (e.g., positive reward for WTRU turning ON when data is sent and negative reward for WTRU turning ON when data is not sent). The reward may be WTRU OFF time miss ratio (e.g., negative reward for WTRU being OFF when data is sent, which can be measured by the NW missing ACK/NACK, and positive reward for WTRU being OFF). The reward may be WTRU OFF time ratio (e.g., computed from the WTRU-determined ON/OFF pattern decided by the WTRU agent and measures the fraction of time the WTRU circuit was turned OFF). WTRU OFF time ratio may measure the efficacy of the WTRU-determined ON/OFF in saving the WTRU power). The stages of the AI/ML process may include “RL Algorithm”. For instance, the agent in the RL algorithm may contain two main components. In some examples, the agent in the RL algorithm may contain policy (e.g., actor). The policy may be a mapping from the current state to a probability distribution of the actions to be taken. Within an agent, the policy may be implemented by a function approximator with tunable parameters and a specific approximation model, such as neural networks. The policy may be also referred as actor. In some examples, the agent in the RL algorithm may contain a learning algorithm (e.g., value function). The learning algorithm may continuously update the policy parameters based on the actions, states, and rewards. The goal of the learning algorithm may be to find an optimal policy that maximizes the expected cumulative long-term reward. A Learning algorithm may be also referred as value function and/or critic. The policy search techniques may target finding the policies through gradient-free and/or gradient-based methods. Examples of policy search methods include actor-critic, deep deterministic policy gradients (DDPG), trust region policy optimization (TRPO), etc. the stages of the AI/ML process may include “Training”. For instance, the WTRU may perform the training through RL framework through a NW DRX feedback message as explained in the method disclosure herein.

When a WTRU is configured with dynamic ON/OFF operations, key parameters may be configured by the NW, which include one or more of the following. For example, a key parameter may be radio resource allocations. In some examples, the WTRU may only receive the radio resource allocations during each ON slot in each DRX cycle. In some examples, the WTRU may receive the radio resource allocations dynamically (e.g., through DCI or MAC-CE).

In some examples, a key parameter may be WTRU ON/OFF feedback report configuration. The WTRU ON/OFF feedback report may include the messages and parameters that should be included in the WTRU ON/OFF feedback report, such as WTRU battery state information, WTRU power profile, WTRU power saving preferences, along with any other relevant information related to the WTRU power saving mechanism and to the latency-energy tradeoff requirement for the WTRU, reward of the WTRU RL framework for training and/or performance monitoring purpose, and/or WTRU-determined ON/OFF pattern (e.g., the ON Slots during the DRX cycle). The WTRU ON/OFF feedback report may include an indication of the updated ON/OFF pattern.

In some instances, the WTRU ON/OFF feedback report configuration may include the reporting condition (e.g., triggering conditions) of the WTRU ON/OFF feedback report. For example, the reporting condition of the WTRU ON/OFF feedback report may be time-based feedback reporting (e.g., the WTRU ON/OFF feedback report can be periodic, aperiodic, or semi-persistent). For example, the mechanism to trigger (e.g. reporting condition) a transmission of the WTRU ON/OFF feedback report may be event-trigger based feedback reporting. For instance, the WTRU computes a certain parameter associated to the reward of its RL framework at the NW. The triggering event of feedback reporting may include the WTRU comparing the computed parameter to some thresholds configured by the NW. The reporting condition may include, for example, an event-triggered reporting condition that is based on a comparison of a value of the reward or a change in the value of the reward and a threshold. The WTRU transmitting of the WTRU ON/OFF feedback report will be triggered if the computed parameter is lower or higher than one of the configured thresholds. Alternatively, the reporting condition of the WTRU ON/OFF feedback report may be a mixture of time-based feedback reporting and event-trigger based feedback reporting. The WTRU may transmit its ON/OFF feedback report upon receiving a request from the NW.

In some instances, the WTRU ON/OFF feedback report configuration can be either preconfigured, configured by means of RRC signaling, and/or dynamically configured (e.g., through DCI or MAC-CE). In some instances, the WTRU ON/OFF feedback report may include the signals and/or the uplink resource configuration and/or allocations that may carry the WTRU ON/OFF feedback report. For example, the resource that may carry the WTRU ON/OFF feedback report may be the PUSCH, PUCCH, RRC, UCI, and/or MAC-CE. In some examples, a WTRU may report WTRU a DRX feedback report in a HARQ-ACK report (e.g., appended to or multiplexed with a HARQ-ACK report). In some examples, the WTRU ON/OFF feedback report configuration may be either preconfigured, configured by means of RRC signaling, and/or dynamically configured (e.g., through DCI or MAC-CE).

The WTRU may receive the configuration of NW DRX feedback message. The NW DRX feedback message may include latency induced from the DRX pattern generated by the NW and/or the WTRU-determined ON/OFF pattern determined by the WTRU. The NW DRX feedback message may include buffer status of DL data for the WTRU and/or the buffer status of the NW. The NW DRX feedback message may include the statistics of missing ACK/NACK messages (e.g., possibly resulting from the WTRU-determined ON/OFF pattern operations). In some examples, the NW DRX feedback message configuration may include the type(s) of signals and/or the downlink resource configuration and/or allocations that carry the NW DRX feedback message. For example, the WTRU may receive the feedback message dynamically (e.g., through DCI or MAC-CE). For example, the NW may ‘piggyback’ the feedback message when other DL transmissions are present. In some examples, the network DRX feedback message may be configured in accordance with the network DRX feedback message configuration.

For dynamic ON/OFF operations, signaling may be defined as follows. For example, signaling may be defined as the WTRU ON/OFF feedback report. The WTRU ON/OFF feedback report may include WTRU battery state information, WTRU power profile, WTRU power saving preferences, along with any other relevant information related to the WTRU power saving mechanism and to the latency-energy tradeoff requirement for the WTRU, reward of the WTRU RL framework for training and/or performance monitoring purpose, and/or WTRU-determined ON/OFF pattern (e.g., the ON Slots during the DRX cycle). For example, signaling may be defined as the NW DRX feedback message. The NW DRX feedback message may include latency induced from the DRX pattern generated by the NW and/or the WTRU-determined ON/OFF pattern determined by the WTRU. The NW DRX feedback message may include buffer status. The NW DRX feedback message may include missing ACK/NACK messages (e.g., possibly resulting from the WTRU-determined ON/OFF pattern operations).

1. A wireless transmit/receive unit (WTRU) comprising:
a processor configured to:
receive configuration information from a network, wherein the configuration information indicates information to be included in an ON/OFF feedback report and a reporting condition associated with sending of the ON/OFF feedback report;
receive a network discontinuous reception (DRX) feedback message from the network, wherein the network DRX feedback message comprises one or more of an indication of a latency induced from a DRX pattern generated by the network, a latency induced by an ON/OFF pattern determined by the WTRU, or a buffer status of downlink data for the WTRU queued at the network;
determine a state and a reward for a reinforcement learning (RL) model of the WTRU based on the received network DRX feedback message;
determine an updated ON/OFF pattern using the RL model of the WTRU based on the state and the reward, wherein the updated ON/OFF pattern is for an interval of time; and
send the ON/OFF feedback report to the network based on the reporting condition being satisfied.

2. The WTRU of claim 1, wherein the ON/OFF feedback report comprises one or more of battery state information associated with the WTRU, a power profile of the WTRU, a power saving preference of the WTRU, the reward of the RL model of the WTRU, or an indication of the updated ON/OFF pattern.

3. The WTRU of claim 1, wherein the processor is configured to:
receive from a network (NW) a request to transmit ON/OFF learning and operation capabilities; and
transmit a capabilities message indicating WTRU support for dynamic ON/OFF operation.

4. The WTRU of claim 1, wherein the interval of time comprises one or multiple time slots, and wherein the number of time slots are i-s configured by the NW.

5. The WTRU of claim 1, wherein the configuration information comprises a network DRX feedback message configuration, and wherein the network DRX feedback message is configured in accordance with the network DRX feedback message configuration.

6. The WTRU of claim 5, wherein the network DRX feedback message configuration indicates whether the network DRX feedback message will include one or more of the latency induced from the DRX pattern generated by the network, the latency induced by the ON/OFF pattern determined by the WTRU, the buffer status of the network, or missing ACK/NACK messages.

7. The WTRU of claim 1, wherein the state of the RL model comprises a history of one or more of ON and OFF slots, data reception slots, or feedback messages from the network, and wherein the reward of the RL model comprises one or more of latency, on time hit ratio, off time miss ratio, or off time ratio.

8. The WTRU of claim 1, wherein the processor is configured to determine the ON/OFF pattern for the next DRX cycle based on the state and the reward of the RL model of the WTRU.

9. The WTRU of claim 1, wherein the reporting condition comprises a periodic reporting condition, an aperiodic reporting condition, or a semi-persistent reporting condition.

10. The WTRU of claim 1, wherein the reporting condition comprises an event-triggered reporting condition that is based on a comparison of a value of the reward or a change in the value of the reward and a threshold.

11. A method performed by a wireless transmit/receive unit (WTRU), the method comprising:
receiving configuration information from a network, wherein the configuration information indicates information to be included in an ON/OFF feedback report and a reporting condition associated with sending of the ON/OFF feedback report;
receiving a network DRX feedback message from the network, wherein the network DRX feedback message comprises one or more of an indication of a latency induced from a discontinuous reception (DRX) pattern generated by the network, a latency induced by an ON/OFF pattern determined by the WTRU, or a buffer status of downlink data for the WTRU queued at the network;
determining a state and a reward for a reinforcement learning (RL) model of the WTRU based on the received network DRX feedback message;
determining an updated ON/OFF pattern using the RL model of the WTRU based on the state and the reward, wherein the updated ON/OFF pattern is for an interval of time; and
sending the ON/OFF feedback report to the network based on the reporting condition being satisfied.

12. The method of claim 11, wherein the ON/OFF feedback report comprises one or more of battery state information associated with the WTRU, a power profile of the WTRU, a power saving preference of the WTRU, the reward of the RL model of the WTRU, or an indication of the updated ON/OFF pattern.

13. The method of claim 11, wherein the method comprises:
receiving from a network (NW) a request to transmit ON/OFF learning and operation capabilities; and
transmitting a capabilities message indicating WTRU support for dynamic ON/OFF operation.

14. The method of claim 11, wherein the interval of time comprises one or multiple time slots, and wherein the number of time slots are i-s configured by the NW.

15. The method of claim 11, wherein the configuration information comprises a network DRX feedback message configuration, and wherein the network DRX feedback message is configured in accordance with the network DRX feedback message configuration.

16. The method of claim 15, wherein the network DRX feedback message configuration indicates whether the network DRX feedback message will include one or more of the latency induced from the DRX pattern generated by the network, the latency induced by the ON/OFF pattern determined by the WTRU, the buffer status of the network, or missing ACK/NACK messages.

17. The method of claim 11, wherein the state of the RL model comprises a history of one or more of ON and OFF slots, data reception slots, or feedback messages from the network, and wherein the reward of the RL model comprises one or more of latency, on time hit ratio, off time miss ratio, or off time ratio.

18. The method of claim 11, wherein the method comprises determining the ON/OFF pattern for the next DRX cycle based on the state and the reward of the RL model of the WTRU.

19. The method of claim 11, wherein the reporting condition comprises a periodic reporting condition, an aperiodic reporting condition, or a semi-persistent reporting condition.

20. The method of claim 11, wherein the reporting condition comprises an event-triggered reporting condition that is based on a comparison of a value of the reward or a change in the value of the reward and a threshold.
